(19) United States
(12) Patent Application Publication
(10) Pub. No.: US 2026/0004136 A1
(43) Pub. Date: Jan. 1, 2026

(54) SELF-SUPERVISED LEARNING OF AMBIGUOUS ZONE OF AN EMBEDDING SPACE

(71) Applicant: AUTOBRAINS TECHNOLOGIES LTD, Tel Aviv-Yafo (IL)

(72) Inventors: Igal RAICHELGAUZ, Tel Aviv (IL); Tomer COHEN, Tel Aviv-Yafo (IL)

(73) Assignee: AUTOBRAINS TECHNOLOGIES LTD, Tel Aviv-Yafo (IL)

(21) Appl. No.: 18/759,891

(22) Filed: Jun. 30, 2024

(51) Int. Cl. G06N 3/0895; G06N 3/045; G06V 20/56

(52) U.S. Cl. CPC G06N 3/0895; G06N 3/045; G06V 20/56

(57) ABSTRACT

A method for self-supervised learning of ambiguous zone embedding space, the method includes identifying, by a processing circuit and during a validation process of a first neural network, a set of embeddings that represent a group sensed information units that are associated with a classification confidence level below a threshold; wherein the first neural network was trained by a supervised training process; the set of embeddings defining an ambiguous zone; and triggering a training of a second neural network, in a self-supervised learning process, across the group of sensed information unit.

### BACKGROUND

Neural networks are employed in vehicles for various purposes including the classification of items sensed by sensors related to the vehicle, and providing responses related to driving based on the classification on items.

There is a growing need to increase the accuracy of classification, even when the initial classification process is inaccurate.

### SUMMARY

A method, system and non-transitory computer readable medium as illustrated in the application.

### A BRIEF DESCRIPTION OF THE DRAWINGS

The embodiments of the disclosure will be understood and appreciated more fully from the following detailed description, taken in conjunction with the drawings in which:

FIG. 1 illustrates an example of a system;

FIG. 2 illustrates an example of a system;

FIG. 3 illustrates an example of clusters and ambiguous zones;

FIG. 4 illustrates an example of clusters and new clusters;

FIG. 5 illustrates an example of a method; and

FIG. 6 illustrates an example of a method.

### DETAILED DESCRIPTION

The different figures illustrates examples of units and/or software and/or information items and/or steps and/or components. These examples are provided for brevity of explanation. At least one of the units and/or software and/or information items and/or steps and/or components is optional or mandatory.

According to an embodiment, there is provided a method for self-supervised learning of ambiguous zone of an embedding space (also referred to as an ambiguous zone embedding space), the method includes identifying, by a processing circuit and during a validation process of a first neural network, a set of embeddings that represent a group sensed information units that are associated with a classification confidence level below a threshold; wherein the first neural network was trained by a supervised training process; the set of embeddings defining the ambiguous zone; and triggering a training of a second neural network, in a self-supervised learning process, across the group of sensed information unit.\

According to an embodiment, the method includes training the second neural network, in the self-supervised learning process, across the group of sensed information unit.

According to an embodiment, the method includes identifying, by the processing circuit and during the validation process of the first neural network, another set of embeddings that represent another group of sensed information units that are associated with the classification confidence level below the threshold; wherein the set of embeddings is associated with a road element that differs from another road element associated with the other set of embeddings; the other set of embeddings defining another ambiguous zone that differs from the ambiguous zone; and triggering a training of a third neural network, in a corresponding self-supervised learning process, across the other group of sensed information unit.

According to an embodiment, the method includes associating the set of embeddings with a routing rule for routing, during inference, a sensed information unit represented by an embedding of the set to the second neural network.

According to an embodiment, the sensed information units are sent to the second neural network untagged.

According to an embodiment, the training of the second neural network includes self-supervised learning.

According to an embodiment, the method includes training the first neural network and training the second neural network.

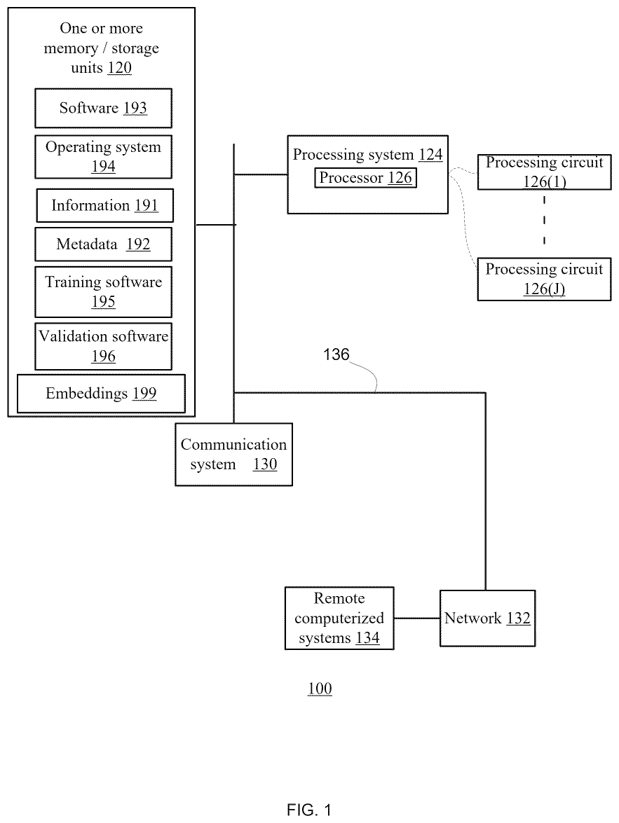

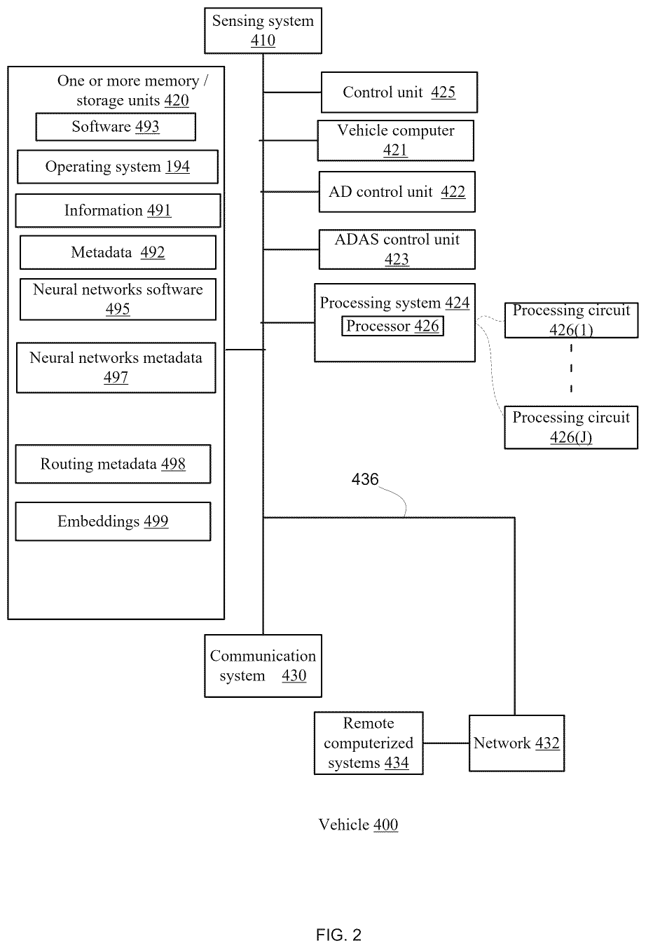

In the following text reference numbers related to FIG. 1 are shown without parenthesis while reference numbers related to FIG. 2 are shown within a parenthesis-whereas any item associated with a reference number without a parenthesis may differ from or equal to the corresponding item within a parenthesis.

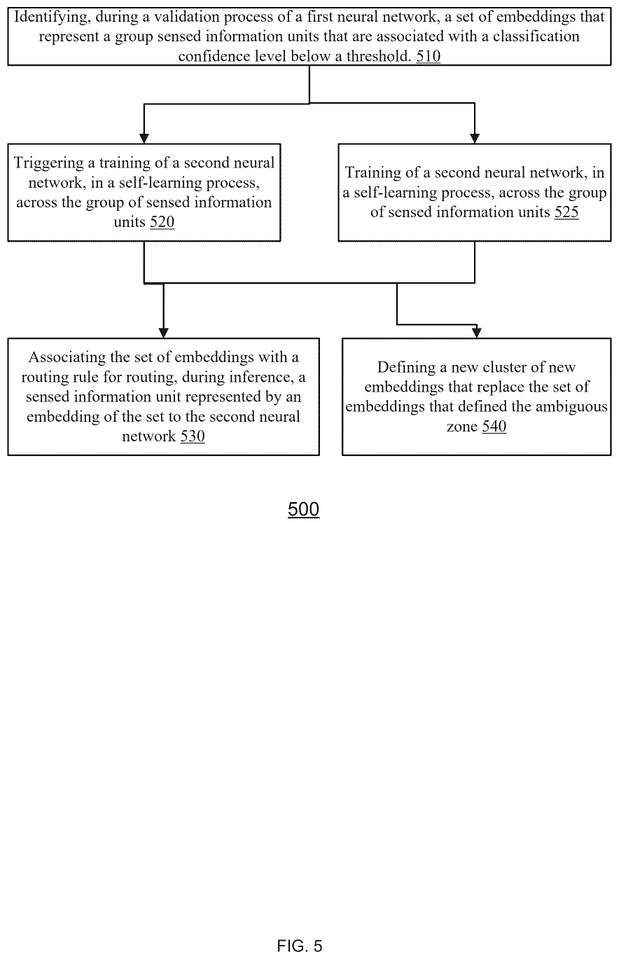

FIG. 1 illustrates an example of a computerized system 100 used to implement method 500 of FIG. 5 during a verification process.

FIG. 2 illustrates an example of vehicle 400 used to perform inference using neural provided by computerized system 500.

Computerized system 100 and vehicle 400 includes communication system 130 (430), one or more memory and/or storage units 120 (420), processing system 124 (424) including processor 126 (426). The communication system 430, the one or more memory and/or storage units 420, and the processing system 424 may belong to a computerized system of vehicle 400. The computerized system may be a server, a laptop, a desktop or any other computer and may include or be in communication with a sensing unit and/or a controller.

According to an embodiment, computerized system 100 and vehicle 400 are in communication with network 132 (432) and one or more other remote computerized systems 134 (434) that are in communication with network 132 (432). An example of a remote computerized system is a server or one or more computers having access to a storage system that stores items related to one or more portions of one or more groups of neural networks—at least some of which are not currently stored in the vehicle.

According to an embodiment, the communication system 130 (430) is configured to enable communication between the one or more memory and/or storage units 120 (420) and/or any one of the additional units and/or the network 132 (432) (that is in communication with the remote computerized systems). Communication system 430 is also configured to enable communication with other elements such as sensing system 410, control unit 425, vehicle computer 421, autonomous driving control unit 422 (denoted AD control unit), advanced driver assistance system (ADAS) control unit 423 (denoted ADAS control unit), and the like.

The memory and/or storage units 120 (420) was shown as storing software. Any reference to software should be applied mutatis mutandis to code and/or firmware and/or instructions and/or commands, and the like.

Processor 126 (426) includes a plurality of processing units 126(1)-126(J) [426(1)-426(J)], J is an integer that exceeds one. Any reference to one unit or item should be applied mutatis mutandis to multiple units or items. For example—any reference to processor should be applied mutatis mutandis to multiple processors, any reference to communication system 130 (430) should be applied mutatis mutandis to multiple communication systems.

According to an embodiment, the one or more memory and/or storage units 120 (420) includes one or more memory unit, each memory unit may include one or more memory banks.

According to an embodiment, the one or more memory and/or storage units 120 (420) includes a volatile memory and/or a non-volatile memory. The one or more memory and/or storage units 120 (420) may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory and/or storage units.

According to an embodiment, the at least one memory unit stores at least one database—such as any database known in the art—such as DB2®, Microsoft® Access, Microsoft® SQL Server, Oracle®, mySQL, PostgreSQL, and the like.

The memory and/or storage units 120 (420) are configured to store firmware and/or software, one or more operating systems, data and metadata required to the execution of any of the methods mentioned in this application.

The memory and/or storage units 120 (420) was shown as storing software. Any reference to software should be applied mutatis mutandis to code and/or firmware and/or instructions and/or commands, and the like.

Various units and/or components are in communication with each other using any communication elements and/or protocols. An example of a communication system is denoted 130 (430). Other communication elements may be provided.

The communication system 130 (430) may be in communication with bus 136 (436). The bus represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 132 (432) that is located outside the vehicle and is used for communication between the vehicle and at least one remote computing system. By way of example, a remote computing system can be a personal computer, a laptop computer, portable computer, a server, a router, a network computer, a peer device or other common network node, and so on. Logical connections between the processor and either one of remote computing systems can be made via a local area network (LAN) and a general wide area network (WAN). Such network connections can be through a network adapter (may belong to communication system 130 (430)) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 120 (420) may be stored outside the vehicle. It should also be noted that the processor may evaluate signatures generated by a plurality of detectors.

Examples of generating signatures and/or cropping images are provided in U.S. patent application Ser. No. 18/527,701 which is incorporated herein by reference.

According to an embodiment, the memory and/or storage units 120 stores at least one of: operating system 194, information 191, metadata 192, and software 193. Examples of software includes training software 195 for performing training of one or more neural network, and validation software 196 for performing a validation process that includes execution of method 500. When method 500 includes performing training—the training is implemented by using training software 195. Examples of metadata includes embeddings 199 that are clustered to multiple clusters and may also include embeddings that are within one or more ambiguous zones.

Using the software, the processing system is configured to execute method 500.

According to an embodiment, the memory and/or storage units 420 stores at least one of: operating system 494, information 191, metadata 192, and software 193.

Examples of software include neural networks software 495 for implementing neural network processing (for example during inference). Examples of information includes embeddings 499. Examples of metadata includes routing metadata 498 that defined rules for routing sensed information units (or any outcome of processing the sensed information units) to a relevant neural network, and embedding neural network metadata 497 such as neural network weights and/or bias and the like.

Using software 495, the processing system is configured to execute method 600.

The control unit 425 may cooperate with ADAS control unit 423 and/or with AD control unit 482 and/or may control or communicate with other vehicle components-including vehicle computer.

The ADAS control unit 423 is configured to control ADAS operations.

The AD control unit 422 is configured to control autonomous driving of the autonomous vehicle.

The vehicle computer 421 is configured to control the operation of the vehicle—especially controlling the engine, the transmission, and any other vehicle system or component.

The vehicle computer 421 may be in communication with an engine control module, a transmission control module, a powertrain control module, and the like.

The sensing system 410 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 410 is configured to output one or more sensed information units (SIUs).

The control unit 425 is configured to control the operation of the sensing system 410, and/or the one or more memory and/or storage units 420 and/or the one or more additional units (except the controller).

By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of the memory and/or storage units.

According to an embodiment, the at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 430. Other communication elements may be provided.

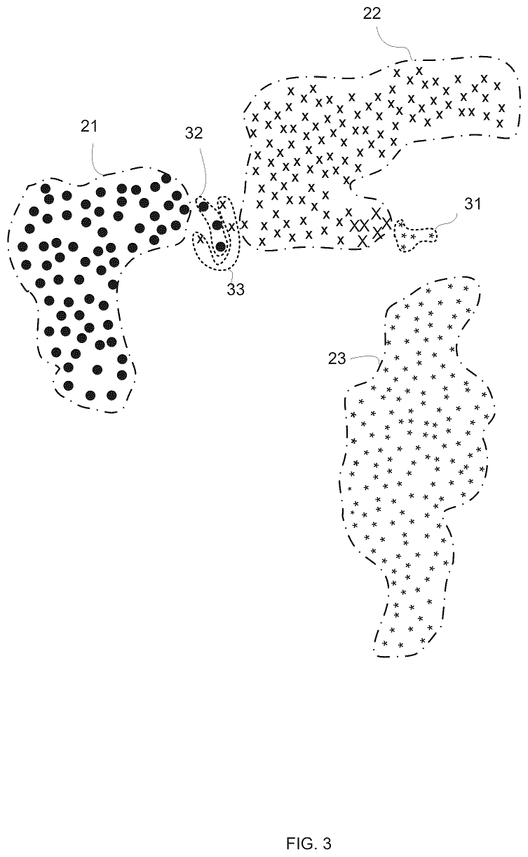

FIG. 3 illustrates an example of clusters and ambiguous zones.

First cluster 21 includes embeddings (represented by black circles) of a first class that are associated with a classification confidence level that is not below a threshold.

Second cluster 22 includes embeddings (represented by “x”) of a second class that are associated with a classification confidence level that is not below the threshold.

Third cluster 23 includes embeddings (represented by “*”) of a third class that are associated with a classification confidence level that is not below the threshold.

Each one of first ambiguous zone 31, second ambiguous zone 32 and third ambiguous zone 33 include embeddings that are associated with a classification confidence level that is below the threshold.

Following an execution of method 500, the embeddings of the ambiguous zones are properly classified. According to an embodiment, embedding of a single ambiguous zone may be properly classified to one or new classes. According to an embodiment, embedding of multiple ambiguous zones may be properly classified to one or new classes.

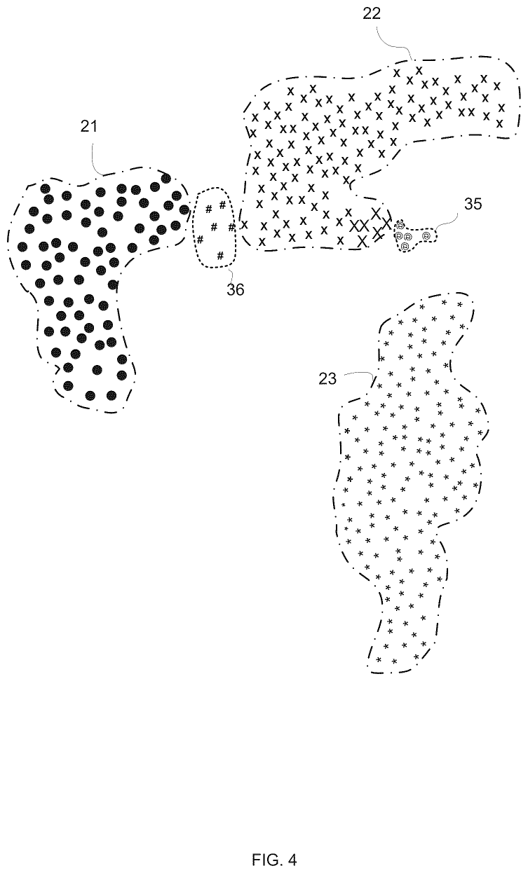

FIG. 4 illustrates an example of first, second and third clusters 21, 22 and 23 as well of a first new cluster 35 that includes embeddings (represented by “@”) of a first new class, and of a second new cluster 36 that includes embeddings (represented by “#”) of a second new class.

FIG. 5 illustrates an example of method 500 for self-supervised learning of ambiguous zone of an embedding space.

According to an embodiment, method 500 includes step 510 of identifying, by a processing circuit and during a validation process of a first neural network, a set of embeddings that represent a group sensed information units that are associated with a classification confidence level below a threshold. The first neural network was trained by a supervised training process. The set of embeddings defining the ambiguous zone.

According to an embodiment, step 510 is followed by step 520 of triggering a training of a second neural network, in a self-supervised learning process, across the group of sensed information units.

According to an embodiment, step 510 is followed by step 525 of training the second neural network, in the self-supervised learning process, across the group of sensed information units.

According to an embodiment, step 520 and/or step 525 are also followed by step 530 of associating the set of embeddings with a routing rule for routing, during inference, a sensed information unit represented by an embedding of the set to the second neural network. The routing will allow the correct neural network (the neural network trained to generate the embeddings that will lead to an accurate classification) to receive the sensed information unit.

According to an embodiment the second neural network, once trained, will participate in the generation of accurate embeddings that replace the embeddings of the ambiguous zone. The generation of the embedding may include post-neural processing—for example for converting neural network output features to embeddings.

According to an embodiment step 520 and/or step 530 are followed by step 540 of defining a new cluster of new embeddings that replace the set of embeddings that defined the ambiguous zone.

According to an embodiment, steps 510, 520, 525, 530 and 540 are repeated multiple times to provide multiple neural networks—each fit to generate embeddings leading to accurate classification.

According to an embodiment, a repetition of steps 510, 520 and 530 includes (i) identifying, by the processing circuit and during the validation process of the first neural network, another set of embeddings that represent another group of sensed information units that are associated with the classification confidence level below the threshold; wherein the set of embeddings is associated with a road element that differs from another road element associated with the other set of embeddings; the other set of embeddings defining another ambiguous zone that differs from the ambiguous zone; (ii) training or triggering a training of a third neural network, in a corresponding self-supervised learning process, across the other group of sensed information units.

According to an embodiment, the sensed information units are sent to the second neural network untagged.

According to an embodiment, the training of the second neural network comprises self-supervised learning.

Self-supervised learning is a type of machine learning where the system learns from the data itself without explicit labels. Instead, the data provides the supervisory signals. This approach is particularly useful when labeled data is scarce or expensive to obtain. Here are some examples of self-supervised learning algorithms and their applications:
A. Contrastive Learning. Algorithm: SimCLR (Simple Framework for Contrastive Learning of Visual Representations). Application: Learning image representations by maximizing agreement between differently augmented views of the same image while minimizing agreement between views of different images.
B. Autoencoders. Algorithm: Variational Autoencoders (VAE). Application: Learning a compressed representation of data by training the network to reconstruct the input data from a compressed latent space. Used in tasks like image denoising and anomaly detection.
C. Masked Language Modeling. Algorithm: BERT (Bidirectional Encoder Representations from Transformers). Application: Predicting missing words in a sentence. Used for tasks like text classification, question answering, and language translation.
D. Contextual Pre-training. Algorithm: GPT (Generative Pre-trained Transformer). Application: Pre-training a language model on a large corpus of text by predicting the next word in a sequence. Used for text generation, summarization, and other natural language processing tasks.
E. Contextual Contrastive Learning Algorithm: MoCo (Momentum Contrast). Application: Learning visual representations by comparing augmented versions of images. Used in computer vision tasks such as object detection and image segmentation.
F. Denoising Autoencoders. Algorithm: Denoising Autoencoders. Application: Training a network to reconstruct clean data from noisy input, helping to learn robust data representations. Used in image and signal processing. Self-Prediction Tasks Algorithm: BYOL (Bootstrap Your Own Latent). Application: Learning image representations by predicting the network's own output for an augmented version of an image. Used for image classification and other visual tasks.
G. Temporal Contrastive Learning. Algorithm: CPC (Contrastive Predictive Coding). Application: Learning representations by predicting future parts of a sequence from past parts. Used in speech recognition, video analysis, and time-series forecasting.
H. RotNet. Algorithm: RotNet (Rotation Net). Application: Predicting the rotation applied to an image. Helps in learning robust visual features. Used for image classification and object detection.
I. Predicting Image Patches. Algorithm: Context Encoders. Application: Predicting missing parts of an image given its context. Used in image inpainting and completion tasks.

These self-supervised learning algorithms leverage the inherent structure in data to create supervisory signals, enabling the learning of useful representations without the need for large labeled datasets.

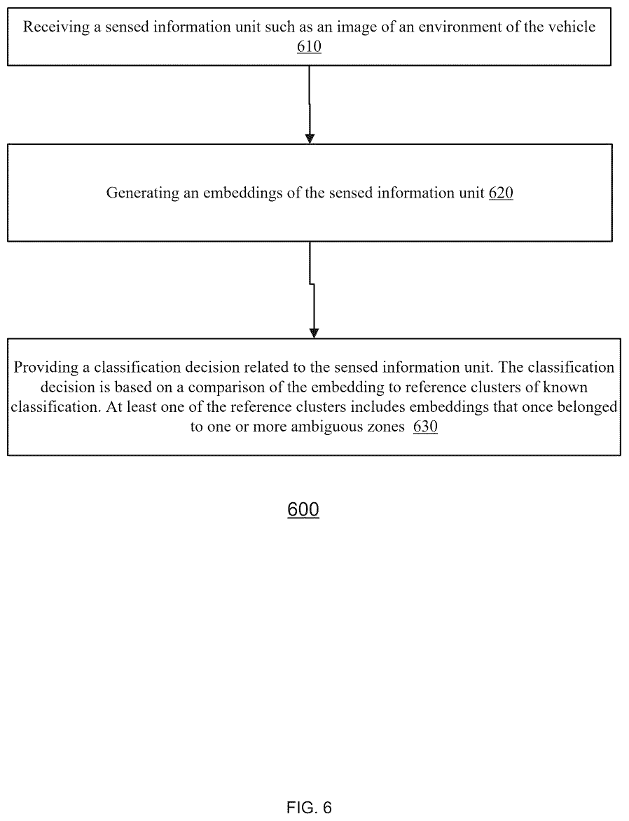

FIG. 6 illustrates method 600 for inference.

According to an embodiment, method 600 includes step 610 of receiving a sensed information unit such as an image of an environment of the vehicle.

According to an embodiment, step 610 is followed by step 620 of generating an embeddings of the sensed information unit. Examples for generating an embeddings are illustrated in U.S. patent application Ser. No. 18/595,368 filing date Mar. 4, 2024 which is incorporated herein by reference.

According to an embodiment, step 620 is followed by step 630 of providing a classification decision related to the sensed information unit, the classification decision is based on a comparison of the embedding to reference clusters of known classification. At least one of the reference clusters includes embeddings that once belonged to one or more ambiguous zones. The at least one cluster could be generated by executing method 500.

Any combination of any step of any method illustrated in the application is provided.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarding the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

Any one of transformation module, active learning module, or clustering module, or any other module described herein, may be implemented in hardware and/or code, instructions and/or commands stored in a non-transitory computer readable medium, may be included in a vehicle, outside a vehicle, in a mobile device, in a server, and the like.

The vehicle may be any type of vehicle—such as a ground transportation vehicle, an airborne vehicle, or a water vessel.

The specification and/or drawings may refer to an image. An image is an example of sensed information. Any reference to an image may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to sensed information. The sensed information may be of any kind and may be sensed by any type of sensors—such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent the signal that was transmitted, or otherwise reach the sensor.

The self-supervised learning is an example of unsupervised learning—or at least to a learning process that initially receives untagged information. Any reference to self-supervised learning should be applied, mutatis mutandis, to unsupervised learning—or at least to a learning process that initially receives untagged information.

The specification and/or drawings may refer to a processor. The processor may be a processing circuitry (also referred to as a processing circuit). The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Any reference to an object may be applicable to a pattern. Accordingly-any reference to object detection is applicable mutatis mutandis to a pattern detection.

A situation may be a singular location, or optionally a combination of properties identified at a specified point in time. A scenario is a series of events that follow logically within a causal frame of reference. Any reference to a scenario should be applied mutatis mutandis to a situation.

The sensed information unit may be sensed by one or more sensors of one or more types. The one or more sensors may belong to the same device or system—or may belong to different devices of systems.

We claim:

1. A method for self-supervised learning of ambiguous zone embedding space, the method comprises:
identifying, by a processing circuit and during a validation process of a first neural network, a set of embeddings that represent a group sensed information units that are associated with a classification confidence level below a threshold; wherein the first neural network was trained by a supervised training process; the set of embeddings defining an ambiguous zone;
triggering a training of a second neural network, in a self-supervised learning process, across the group of sensed information unit;
identifying, by the processing circuit and during the validation process of the first neural network, another set of embeddings that represent another group of sensed information units that are associated with the classification confidence level below the threshold; wherein the set of embeddings is associated with a road element that differs from another road element associated with the other set of embeddings; the other set of embeddings defining another ambiguous zone that differs from the ambiguous zone; and
triggering a training of a third neural network, in a corresponding self-supervised learning process, across the other group of sensed information unit.

2. The method according to claim 1, further comprising training the second neural network, in the self-supervised learning process, across the group of sensed information unit.

3. The method according to claim 1, further comprising associating the set of embeddings with a routing rule for routing, during inference, a sensed information unit represented by an embedding of the set to the second neural network.

4. The method according to claim 1, wherein the sensed information units are sent to the second neural network untagged.

5. The method according to claim 1, wherein the training of the second neural network comprises self-supervised learning.

6. The method according to claim 1, further comprising training the first neural network and training the second neural network.

7. The method according to claim 1, further comprising defining a new cluster of new embeddings that replace the set of embeddings that defined the ambiguous zone.

8. A non-transitory computer readable medium for self-supervised learning of ambiguous zone embedding space, the non-transitory computer readable medium stores instructions executable by a processing circuit for:
identifying, during a validation process of a first neural network, a set of embeddings that represent a group sensed information units that are associated with a classification confidence level below a threshold; wherein the first neural network was trained by a supervised training process; the set of embeddings defining an ambiguous zone;
triggering a training of a second neural network, in a self-supervised learning process, across the group of sensed information unit;
identifying, by the processing circuit and during the validation process of the first neural network, another set of embeddings that represent another group of sensed information units that are associated with the classification confidence level below the threshold; wherein the set of embeddings is associated with a road element that differs from another road element associated with the other set of embeddings; the other set of embeddings defining another ambiguous zone that differs from the ambiguous zone; and
triggering a training of a third neural network, in a corresponding self-supervised learning process, across the other group of sensed information unit.

9. The non-transitory computer readable medium according to claim 8, further storing instructions executable by the processing circuit for training the second neural network, in the self-supervised learning process, across the group of sensed information unit.

10. The non-transitory computer readable medium according to claim 8, further storing instructions executable by the processing circuit for associating the set of embeddings with a routing rule for routing, during inference, a sensed information unit represented by an embedding of the set to the second neural network.

11. The non-transitory computer readable medium according to claim 8, wherein the sensed information units are sent to the second neural network untagged.

12. The non-transitory computer readable medium according to claim 8, wherein the training of the second neural network comprises self-supervised learning.

13. The non-transitory computer readable medium according to claim 8, further storing instructions executable by the processing circuit for training the first neural network and training the second neural network.

14. The non-transitory computer readable medium according to claim 8, further storing instructions executable by the processing circuit for defining a new cluster of new embeddings that replace the set of embeddings that defined the ambiguous zone.
